(19) United States
(12) Patent Application Publication
(10) Pub. No.: US 2015/0014978 A1
(43) Pub. Date: Jan. 15, 2015

(54) Cover, Coupling Element and Folder

(71) Applicant: Innobind Holding B.V., Amsterdam (NL)

(72) Inventor: Paul Gokkel, Bloemendaal (NL)

(21) Appl. No.: 14/374,386

(22) PCT Filed: Jan. 28, 2013
(86) PCT No.: PCT/NL2013/050046

§ 371 Date: Jul. 24, 2014

(30) Foreign Application Priority Data
Jan. 27, 2012 (NL) 2008193
Mar. 26, 2012 (NL) 2008540
Sep. 20, 2012 (NL) 2009497

(51) Int. Cl. B42D 3/12; B42F 3/00; B42B 5/00; B42F 7/04

(52) U.S. Cl. CPC B42D 3/12; B42F 7/04; B42F 3/00; B42B 5/00
USPC 281/34; 229/67.1; 24/67 R; 24/67 AR

(57) ABSTRACT

The present invention relates to a cover for at least partially enclosing a stack, the stack comprising at least two sheets, the cover comprising:
a front cover member for placing at the front side of the stack;
a rear cover member for placing at the rear side of the stack and connected to the front cover member,
a spine crease or spine part on a spine side for connecting the front cover member and the rear cover member at least in the assembled state with the stack, and
front coupling means for coupling the front cover member to the respective side of the stack.

The present invention relates to a cover for at least partially enclosing a stack, the stack comprising at least two sheets.

The present invention further relates to a coupling element for coupling at least two coupling tab stacks.

The present invention also relates to a folder for receiving one or more coupling tab stacks.

A binding system is per se known wherein a stack comprising at least one sheet of paper can be coupled to another stack comprising at least one sheet of paper. The stacks are connected to each other by means of tabs provided on at least one edge of the paper. The tabs of the one stack are offset relative to the tabs of the other stack so that the tabs can mutually engage in or-der to bring about the coupling.

A crease line according to this document comprises a fold line pressed into a sheet material as well as material transitions or hinge means allowing a fold or bend at the possession of said crease line.

Coupling tabs according to this document our tabs defined in accordance with the sense of the previously filed PCT application pct/nl 2006/000088 for mutually coupling sheets which thereby form a stack. A coupling tab stack according to this document is a stack formed by means of sheets with coupling tabs.

A front side of a stack according to this document is understood to mean the front side or the rear side and, depending on the embodiment, can be interpreted in either sense. The use of the wording front side and rear side is therefore intended to be mutually interchangeable, and this wording is used to clarify the text and to avoid designations such as first side and second side.

An advantage of such a system is that a booklet of a number of sheets can be produced in simple manner.

A drawback of sheets with such tabs is that the tabs are always freely accessible from outside. The tabs may become curled as a result.

The present invention has for its object to obviate or at least reduce such a drawback of the known art. The invention provides for this purpose a cover for at least partially enclosing a stack comprising at least two sheets, the cover comprising:
a front cover member for placing at the front side of the stack;
a rear cover member for placing at the rear side of the stack and connected to the front cover member,
a spine crease or spine part on a spine side for connecting the front cover member and the rear cover member at least in the assembled state with the stack, and
front coupling means for coupling the front cover member to the respective side of the stack.

A first advantage of the present invention is that a bound stack with a cover can be provided which remains very easily in folded-open position along the boundary line between the coupling tabs and the remaining parts of the sheets without the sheets having to be held in place, while curling of the coupling tabs is also prevented in effective manner according to the present invention. The stack even remains substantially flat when folded open. A binding stack bound with sheets without the prior art coupling tabs on or close to the spine has a much greater sheet stiffness, whereby, the stack dis-plays a persistent tendency to fold shut as a result of this sheet stiffness. Opening the stack with cover ac-cording to the invention is realized in that the sheets are easily foldable at the transition between the sheet and the coupling tabs, since substantially half the length per sheet has been removed for the purpose of forming the coupling tabs.

A further advantage is that by binding the front cover member it is possible to arrange a cover round the stack, the stack comprising at least two sheets. By coupling the front cover member to the respective side of the stack, the cover is placed over the mechanism for binding the stack and curling is prevented. A further advantage is that the stack integrity is enhanced by the cover.

A further advantage of the present invention is that the stack, comprising at least two sheets, can in this way be provided with an imprint or with a kind of protection. A stack can in this way be provided which has the advantages of the binding system and can also have an imprint and/or protection.

The invention has diverse preferred embodiments which will become apparent from the description of several such embodiments below. The advantageous inventive features of the invention in all its aspects, including the measures defined in the dependent claims, are by no means limited to the considerations stated above and/or below.

A first preferred embodiment of the cover according to the invention has the feature that it comprises rear coupling means for coupling the rear cover member to the respective side of the stack. An advantage of this embodiment is that, due to the cover being coupled on two sides of the stack, the coupling thereof is more stable. The stack is coupled to the cover on the front side as well as on the rear side.

It is advantageous here for the front coupling means and/or the rear coupling means to comprise attaching means, such as adhesive means, for adhesion to the respective side of the stack. The user of the cover can for instance position the stack relative to the cover in one operation and also couple these two to each other within the same operation. The coupling can after all be effected by arranging and pressing the cover on the stack, while a system such as Docubind™ requires complex operations and an apparatus for placing the sheets in the ring binder strip.

A further preferred embodiment of the cover according to the invention, for application with a coupling tab stack or a single stack of sheets provided with the coupling tabs, has the feature that the front coupling means or the rear coupling means comprise coupling tabs for coupling to coupling tabs mutually coupling sheets of a coupling tab stack. It is noted that the coupling tabs can function in combination with the attaching means. An advantage of the coupling tabs is that the stack can be positioned relative to the cover before coupling of the stack to the cover. The coupling tabs are in this case first connected to the coupling tabs of the coupling tab stack, and the cover is subsequently coupled to the stack using the attaching means.

Another option is for the coupling tabs to take on the function of the attaching means, as described above. The advantage of positioning the stack relative to the stack is likewise applicable in this option.

A further preferred embodiment of the cover according to the invention has the feature that the front cover member and/or the rear cover member comprises a sheet crease line for the purpose of providing a hinge action at a transition between the coupling tabs and the sheet portions of the sheets forming a coupling tab stack. The sheet crease is advantageous when a user of the cover leafs through the stack when the cover and the stack are assembled, for instance in order to read text printed on the sheets of the stack.

During this operation the user will fold the stack with the cover so as to thus be better able to read the text on the sheet. An advantage of the sheet crease line is that folding of the cover is improved, particularly when the sheet crease line corresponds to the fold line defined by the positioning of the coupling tabs of the coupling tab stack. This allows easier folding open of the combination of the cover and the stack.

A further advantage of the sheet crease line is that no fold lines occur at random positions on the cover. A fold line at a random position on the cover can give the whole a sloppy and untidy appearance, this being prevented by the sheet crease line.

A further embodiment of the cover according to the invention has the feature that the coupling means comprise adhesive means for adhering to the stack from the spine side of the cover as seen from a position beyond the sheet crease line, preferably adjacently of the sheet crease line or less than a strip width of the adhesive means removed therefrom. An advantage of this arrangement is that during placing of the cover on the stack the coupling tabs of the stack remain freely movable relative to the cover, or at least that unintended adhesion of the coupling tabs to an adhesive strip is prevented. An advantage of this embodiment is that the coupling tabs will not affect the appearance of the cover in the assembled state. When the coupling tabs come into contact with the adhesive means during arranging of the cover, the coupling tabs could have the effect on the cover of giving the cover an irregular surface. This effect is prevented by this embodiment.

A preferred embodiment of the cover according to the present invention, has the feature that the coupling means of coupling means for first coupling comprise adhesive means for adhering to the coupling tabs of the coupling tab stack. An advantage of this embodiment is that the cover can be attached to the first side of the stack, wherein the cover and the stack are positioned simultaneously relative to each other. Following positioning the coupling based on adhesive means can be effected, after which the cover is coupled to the second side of the stack. The positioning of the cover relative to the stack will remain the same during this operation, since the coupling based on adhesive means maintains the positioning. The user need therefore position the cover relative to the stack only once.

A further preferred embodiment of the cover according to the present invention has the feature that the front cover member and/or the rear cover member extend over a part or the whole of the surface of the stack. An advantage of this embodiment is that the cover can either serve to hold the stack together or have an additional function, for instance as a full cover. The cover can in this way also serve to impart a desired appearance to the coupling tab stack.

A preferred embodiment of the cover according to the present invention has the feature that the cover comprises at least one adhesive means protective element, such as a pull strip, for covering the adhesive means up to the moment of adhering thereof to the coupling tab stack. The user can remove the adhesive means protective element at a desired moment, for instance when the cover is properly positioned relative to the coupling tab stack. The coupling based on the attaching means can in this way be effected at any desired point in time.

It is advantageous here for the adhesive means protective element to take a dual form in a longitudinal direction thereof for pulling thereof from one side along the length out of an assembly of the stack and the cover. This embodiment enables the user to first position the cover relative to the coupling tab stack before realizing the coupling based on attaching means. When the user is satisfied with the positioning, he/she can remove the adhesive means protective element from the adhesive means without the cover having to be removed from the coupling tab stack. The adhesive means protective element can be pulled out between the cover and the coupling tab stack. The relative orientation between the stack and the cover in this way remains in the positioning effected by the user while bringing about the mutual fixation to be realized by means of adhesion.

A further preferred embodiment of the cover according to the invention has the feature that the cover is manufactured at least partially from a material selected from, the group comprising paper, cardboard, plastic, leather and/or a combination thereof. An advantage of this embodiment is that a user can choose the appearance he/she wishes to impart to the cover. Each type of material can further have determined properties per se, such as for instance plastic having the property that it can repel dirt and leather for instance giving a luxury appearance.

It is advantageous here for the cover to be formed integrally. An integral cover has the advantage that it is easy to arrange, since it can be arranged in one operation. It is also easy to manufacture.

A further aspect of the invention relates to a coupling element for mutually coupling two coupling tab stacks, comprising:
front coupling means for coupling to a first of the two coupling tab stacks;
rear coupling means for coupling to a second of the two coupling tab stacks and connected to the first coupling means,
wherein a folding crease is provided between the first coupling means and the second coupling means.

A first advantage of the coupling element is that two coupling tab stacks can in this way be coupled to each other. It is thus possible to manufacture coupling tab stacks comprising a small number of sheets and to couple these tab stacks to each other later. When a coupling tab stack comprises a large number of sheets, it may occur that the coupling tab stack falls apart due to the weight of the sheets. This risk is reduced by coupling a number of coupling tab stacks to each other, since the weight is then distributed over a number of stacks.

A preferred embodiment of the coupling element according to the invention has the feature that the coupling element comprises attaching means, such as adhesive means, for mutually connecting the front coupling means and the rear coupling means in the assembled state. An advantage of this embodiment is that, by connecting the coupling element to itself, the coupling element remains in the assembled state and the coupling tab stacks likewise remain in this state.

A further aspect of the invention relates to a folder for receiving one or more coupling tab stacks, comprising:
a front cover member for placing at the front side of the stack;
a rear cover member for placing at the rear side of the stack and connected to the front cover member;
a spine part on a spine side for connecting the front cover member and the rear cover member at least in the assembled state with the stack, and
one, or more than one coupling means for coupling the coupling tab stack.

An advantage of a folder according to the invention is that the coupling tab stacks can be stored in the folder and can also be read or leafed through by the user. The stacks are further easy to remove from the folder and the folders can be stored in a storage system. It is noted that the folder can be manufactured in integral form.

A preferred embodiment of the folder according to the invention has the feature that the coupling means forms part of the spine part and/or forms the spine part. An advantage of this embodiment is that a plurality of coupling tab stacks can be placed in the folder. It is for instance possible in this way to keep a file in a folder.

Further advantages, features and details of the present invention will be elucidated on the basis of a number of embodiments with reference to the accompanying figures, in which:

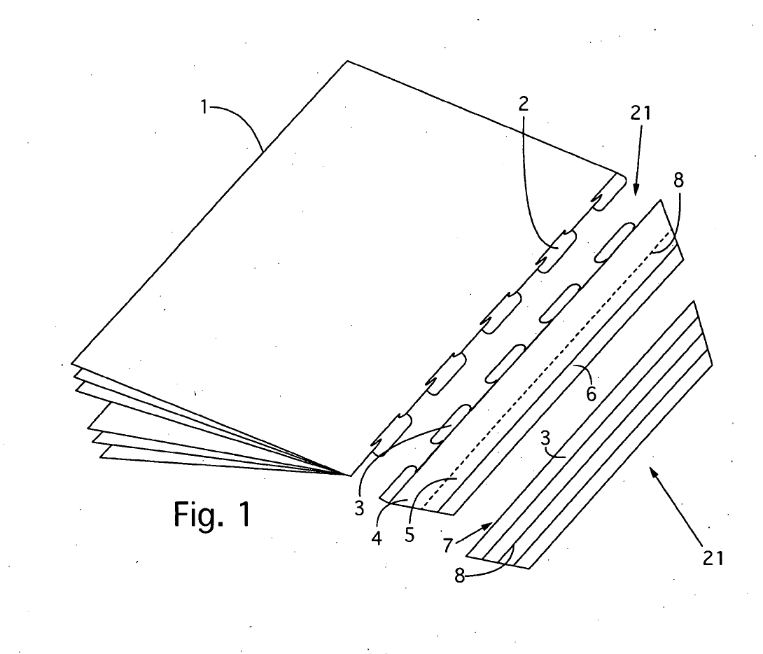

FIG. 1 shows a preferred embodiment of a cover ac-cording to the invention;

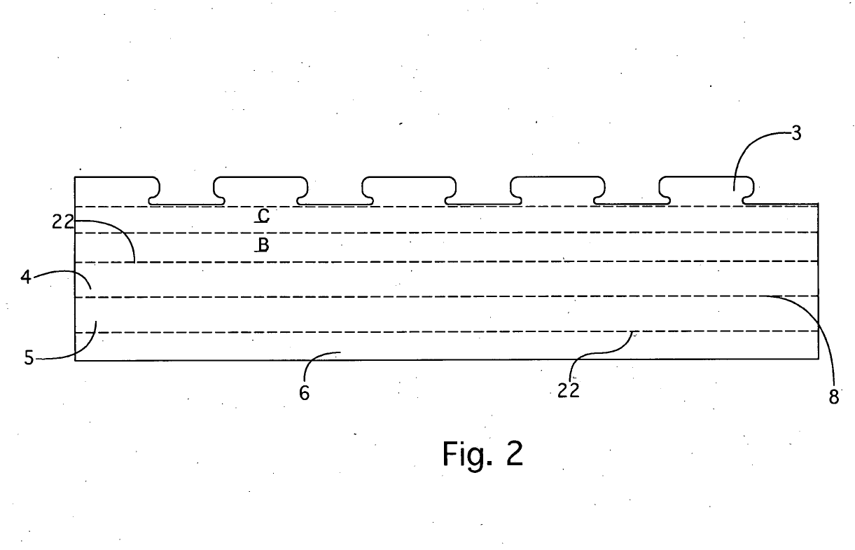

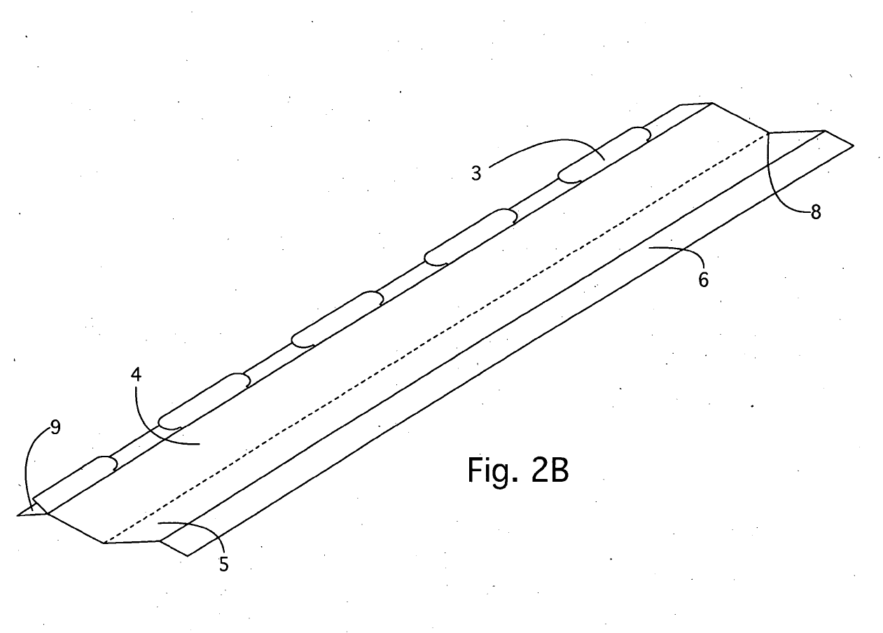

FIGS. 2A and 2B show detailed views of a further embodiment of the cover;

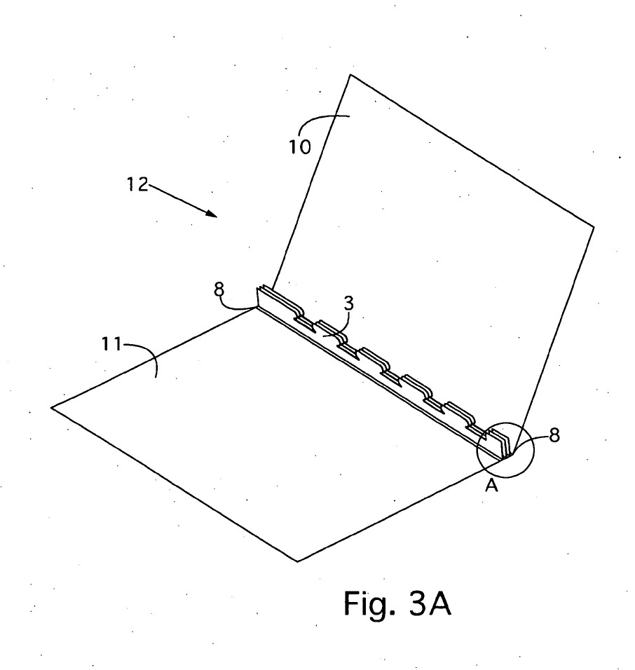

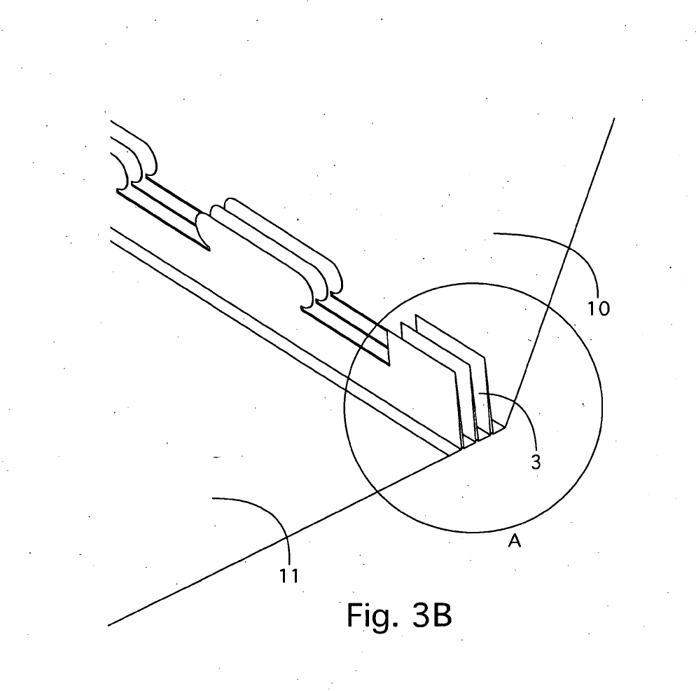

FIGS. 3A and 3B show an embodiment of a preferred embodiment of a folder according to the invention;

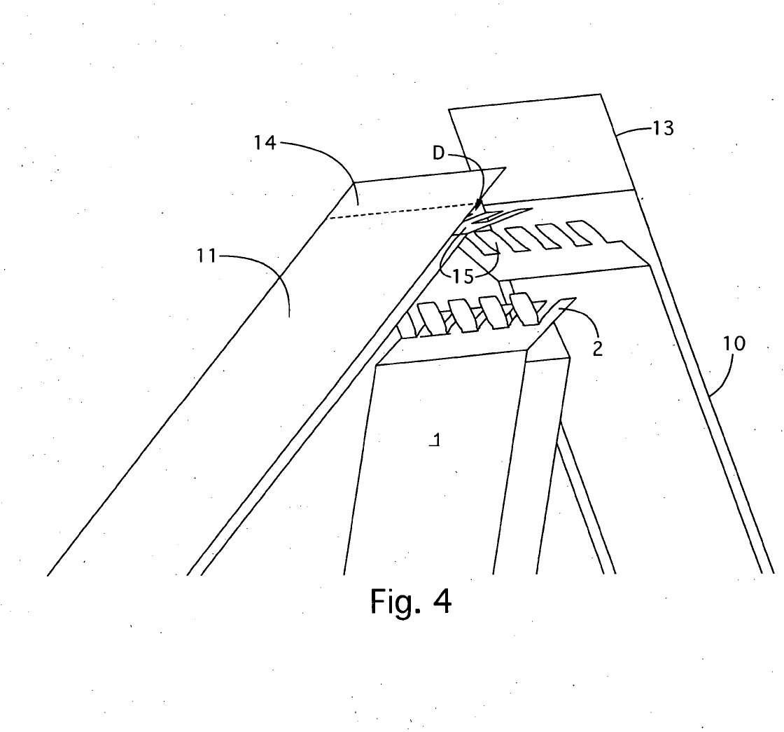

FIG. 4 shows a further preferred embodiment of a cover according to the invention, which embodiment can have an envelope-like structure;

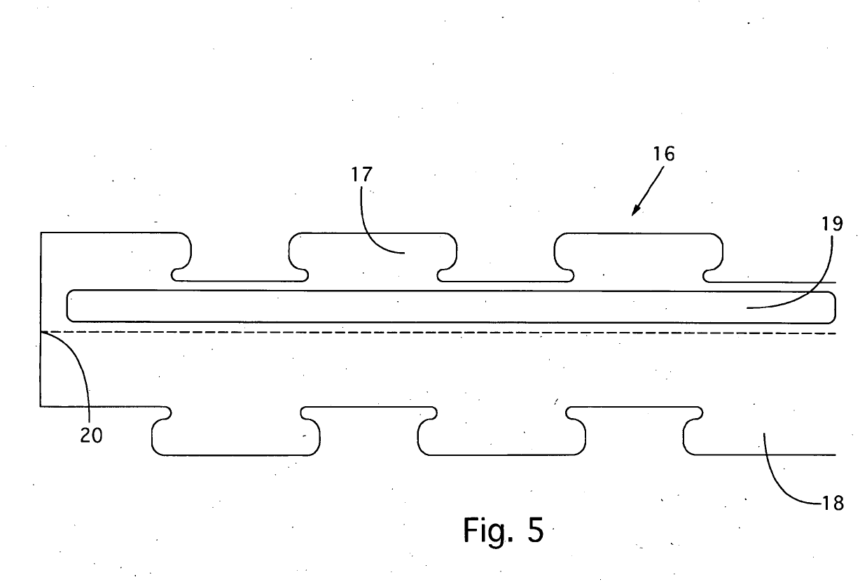

FIG. 5 shows a preferred embodiment of coupling element according to the invention;

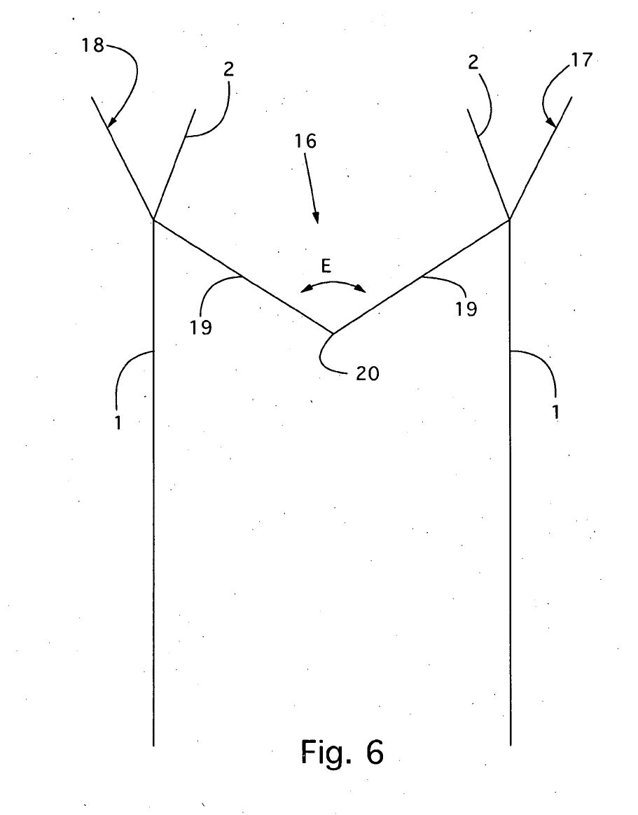

FIG. 6 shows schematically a coupling element in assembled state;

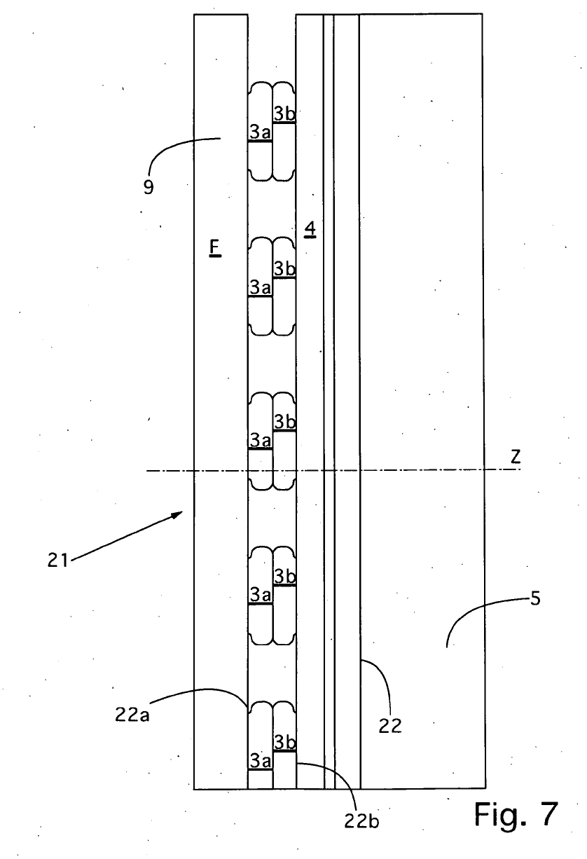

FIG. 7 shows a further preferred embodiment of a cover according to the invention;

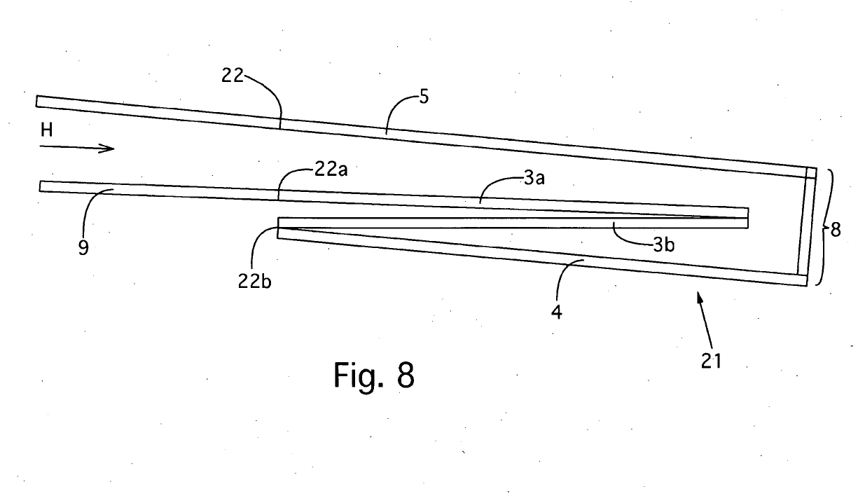

FIG. 8 shows a cross-section through a folded version of the cover of FIG. 7;

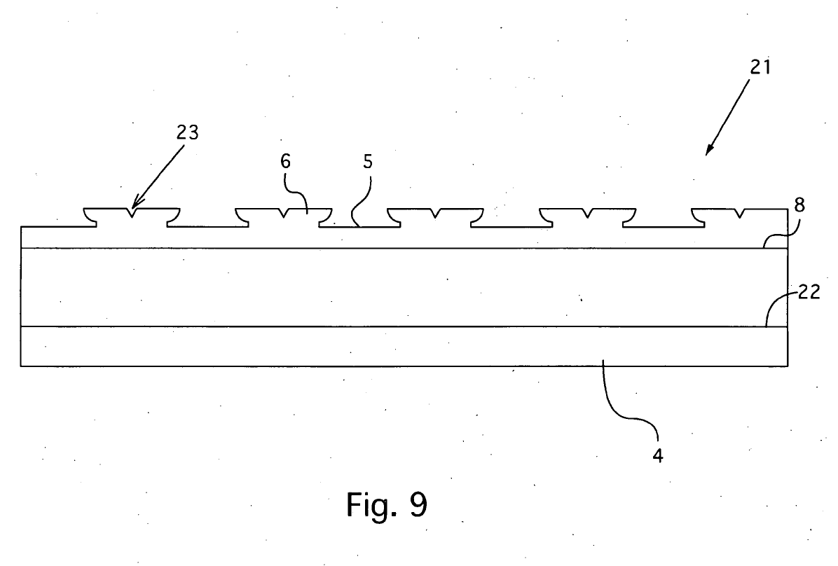

FIG. 9 is a schematic view of a cover as blank; and

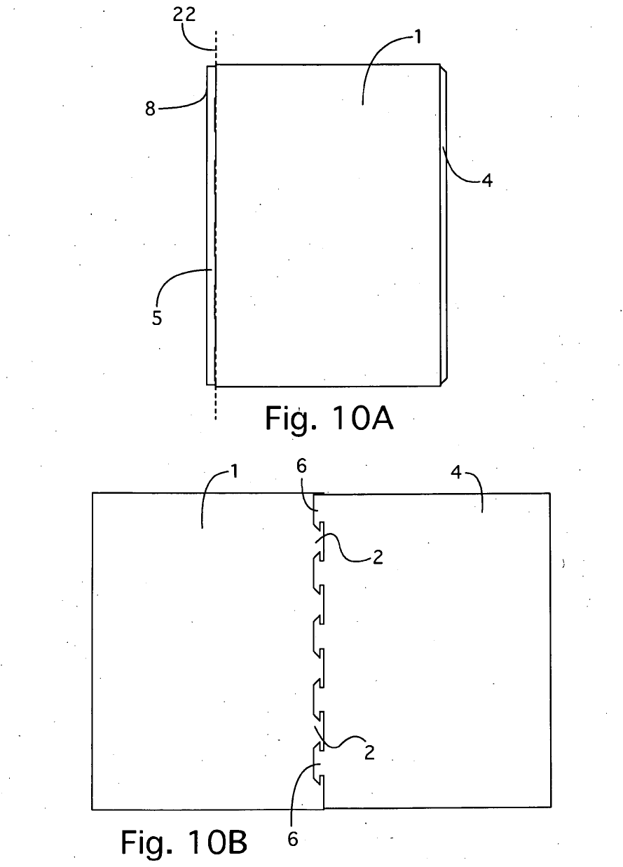

FIGS. 10A and 10B are schematic views of the cover of FIG. 9 in partially coupled and coupled state.

FIG. 1 shows a first embodiment of a cover 21 and an alternative embodiment of cover 21. FIG. 1 further shows a coupling tab stack 1 as described above, wherein the coupling tab stack 1 comprises coupling tabs 2 for the purpose of effecting a coupling. The embodiment of cover 1 shown here comprises a front coupling means 6 connected to a front cover member 5. Cover 1 further comprises rear coupling means 3 which are connected to a rear cover member 4. The rear cover member 4 and front cover member 5 are connected to each other via a spine crease 8.

In the first embodiment the rear coupling means com-prise coupling tabs 3. Coupling tabs 3 can be coupled to coupling tabs 2 of the coupling tab stack 1. Coupling tabs 3 of cover 21 are foldable in the direction of spine crease 8. Arrangement of the cover takes place in a number of steps. Coupling tabs 3 of cover 21 are first of all coupled to coupling tabs 2 of coupling tab stack 1. Coupling tabs 3 are then folded in the direction of spine crease 8. It is noted that adhesive means can optionally be provided on the side of the rear cover member 4 facing to the rear so that it strengthens the coupling in the assembled state. The following step is to fold the cover round the coupling tabs 2 of coupling tab stack 1 so that the front cover member 5 can be coupled to the front side of the coupling tab stack 1. The front cover member 5 is coupled to the front side of the coupling tab stack 1 using adhesive means.

In the alternative embodiment 7 the rear coupling means 3 are formed by attaching means, such as for in-stance an adhesive strip.

FIGS. 2A and 2B show a detailed view of a further embodiment of the cover. The cover likewise comprises rear coupling means 3 and front coupling means 6, as well as a front cover member 5 and a rear cover member 4. This embodiment comprises additional components however, these being designated B and C in FIG. 2A. Before the cover can be coupled to a coupling tab stack 1, the cover has to be folded such that component C comes to lie on component B. One or both components can be provided with an attaching means such as an adhesive strip. The folding operation can be carried out in the factory, or can be performed by an end user. Arranging of the cover is carried out as described above. After arranging of the stack the sheet crease 22 is placed adjacently of the transition between the coupling tabs and the sheets for the purpose of providing a folding action or hinge action when a page is stored in the stack.

FIG. 2B shows the cover in folded position. The elements correspond to the elements as discussed with reference to FIG. 2A. FIG. 2B additionally shows a strip 9 which is formed by folding component B and component C toward each other. Strip 9 is preferably provided with attaching means, such as an adhesive strip, for coupling the strip to the rear side of coupling tab stack 1.

FIGS. 3A and 3B show an embodiment of a preferred embodiment of a folder 12 according to the invention. Folder 12 comprises a front cover member 10 and a rear cover member 11. Further provided are three coupling means 3 for coupling to a coupling tab stack 1. Coupling means 3 form the spine part of folder 12. Coupling means 3 are further connected to respectively the front cover member 10 and rear cover member 11 via a spine crease 8, whereby front cover member 10 and rear cover member 11 are movable relative to the spine part. Folder 12 can be manufactured integrally. Coupling means 3 are for in-stance arranged by means of punching, after which folder 12 is folded into the desired form.

FIG. 3B shows coupling means 3 of folder 12 in more detail. It can be seen that coupling means 3 are each formed from two layers of a material used to manufacture folder 12. The two layers of the material can be coupled to each other, for instance by means of attaching means. A result hereof is that folder 12 retains the shown form.

FIG. 4 shows a further preferred embodiment of a cover according to the invention. The cover comprises a front cover member 11 and a rear cover member 10. The front side 11 and rear side 10 are formed by arranging a sheet provided with coupling means 15 onto another sheet, which can for instance be firmer. At the rear side 10 the coupling means 15 only have to be unattached from the other sheet, while at the front side 11 the coupling means 15 and an additional part of the first sheet have to be unattached relative to the other sheet, this area being indicated with arrow D. A coupling tab stack 1 with coupling tabs 2 is coupled to coupling tabs 15 of the cover. In the assembled state the coupling tab stack is thus coupled to the cover on the front side and the rear side.

A part 13 of the rear cover member 10 is then placed in the above stated area which has been left clear and which is designated with arrow D. As final step, part 14 of the front cover member 11 is coupled to rear cover member 10 using for instance attaching means such as adhesive means. A result hereof is a cover as described above. A further embodiment preferably functions as an envelope with a substantially envelope-like structure provided with coupling means 15 with a flap similar to flap 13 as drawn in this figure, which is placed round the sheet with coupling means 15. This envelope and/or the sheet can comprise an adhesive strip for holding the sheet in the envelope.

FIG. 5 shows a preferred embodiment of a coupling element 16 according to the invention. Coupling element 16 comprises a front coupling means 17 and a rear coupling means 18. A fold line 20 is provided between front coupling means 17 and rear coupling means 18. Front coupling means 17 can be coupled to a front side of a first coupling tab stack, while rear coupling means 18 can be coupled to a rear side of second coupling tab stack. In the assembled state two coupling tab stacks are in this way coupled to each other. It is of course possible to couple a plurality of coupling tab stacks to each other using a plurality of coupling elements 16.

Attaching means 19, such as adhesive means, are optionally provided on coupling element 16. In the assembled state these attaching means 19 can hold front coupling means 17 and rear coupling means 18 in the assembled state so that the stacks remain together.

FIG. 6 shows schematically a coupling element 16 in assembled state. Shown is a coupling element 16 which is coupled by means of a front coupling means 17 to a front side of a first coupling tab stack 1, and by means of a rear coupling means 18 to a rear side of a second coupling tab stack 1. Coupling element 16 is folded round fold line 20. The two parts of coupling element 16 can be moved toward each other in the direction of arrow E so as to be thus coupled to each other as described above. The points 17 and 18 finally come to be arranged against each other.

It is noted that a cover according to the invention can be arranged on two or more coupling tab stacks which are coupled to each other by means of the coupling element according to the invention.

FIG. 7 shows a further preferred embodiment of a cover 21 according to the invention. Cover 2 comprises a front cover member 5 which is located during use on a front side of a stack of sheets. The front cover member 5 can be further attached to for instance the front side of a stack of sheets using a front coupling means 6, such as an adhesive strip which in non-applied state is provided with a protective element. Front cover member 5 is further provided with a crease line 22 which is located in arranged state at the position of the base of the coupling tabs. Cover 21 further comprises rear coupling means 3, which in this embodiment take the form of coupling tabs 3. Coupling tabs 3 are formed in this embodiment by placing coupling tabs 3a and 3b against each other (in the folded position). Coupling tabs 3 are connected to a rear cover member 4 which in the arranged state cover the coupling tabs 3 so that they are not visible to a user and the coupling tabs 3 are protected from outside influences. FIG. 7 additionally shows a strip 9 which is formed during forming of coupling tabs 3. Strip 9 is preferably provided with attaching means, such as an adhesive strip F, for coupling the strip to the rear side of the stack of sheets.

Rear cover member 4 is connected to front cover member 5 via a spine element 8. It is noted that spine element 8 can also be a spine crease line (not shown). In the arranged state crease lines 22A and 228 come to lie one on the other. Rear cover member 4 is optionally provided with an attaching strip so that rear cover member 4 can be attached to coupling tabs 3. Front cover member 5 can also be provided with a crease line 22 so that the whole entity is readily foldable.

It is further noted that cover 21 can be coupled to a single stack of sheets provided with coupling tabs without these sheets having been mutually coupled using the coupling tabs.

FIG. 8 shows a cross-section of a folded version of cover 21 of FIG. 7. The cross-section is taken along line Z as shown in FIG. 7. Cover 21 is shown in the figure such that the stack of sheets (not shown) is placed in the direction of arrow H into cover 21. Cover 21 is arranged in the following manner. Coupling tabs 3 are coupled on the rear side of the stack of sheets to the coupling tabs of the sheets. Rear cover member 4 is then folded over coupling tabs 3 so that these coupling tabs 3 are covered. Shown clearly in this figure is that the separate coupling tabs 3a and 3b are in the vicinity of each other in order to form the coupling tabs 3. The following step is to fold the front cover member 5 round spine element 8 and optionally to attach the front cover member 5 to the front side of the stack of sheets (not shown) using attaching means 6 (not shown). As final step the strip 9, which is provided with attaching means, can be arranged on the rear side of the stack of sheets.

The front cover member 5 and/or, strip 9 optionally extends over a part or the whole of the surface of the stack. It is likewise possible for an additional protective element to be provided on front cover member 5 and/or strip 9.

Advantages of the embodiment of the cover 21 shown in FIG. 7 and FIG. 8 is that the cover can be manufactured relatively easily and at favourable cost. The cover is folded round a fold line running parallel to crease line 22, thereby creating a double edge. The coupling tabs are arranged in this edge. Cover 21 is further provided with attaching means and crease lines as described above. Cover 21 is also easy for a user to arrange.

FIG. 9 shows a schematic view of a cover 21 as blank. Cover 21 comprises coupling tabs 6 arranged on front cover member 5. Front cover member 5 is connected to rear cover member 4 by means of a spine crease 8. Cover 21 is folded round the front side and rear side of coupling tab stack 1 at spine crease 8. Rear cover member 4 is further provided with a sheet crease line 22 for the purpose of providing in the coupled state a hinge action at the transition between coupling tabs 2 and the remaining part of coupling tab stack 1.

V-shaped notches 23 further provided in coupling tabs 6 of cover 21. An advantage of these V-shaped notches 23 is that coupling tabs 6 are substantially divided into two separate parts which are movable relative to each other, thereby increasing the flexibility of coupling tabs 6. A result hereof is that coupling tabs 6 of cover 21 can be coupled more easily to the coupling tabs of coupling tab stack 1.

FIGS. 10A and 10B show schematic views of cover 21 of FIG. 9 in partially coupled and coupled state. FIG. 10A shows, from the front side of the coupling tab stack, the cover 21 coupled to coupling tab stack 1. Shown is the title page of the coupling tab stack 1, the front cover member 5 which lies over coupling tabs 6 and ad-joins the spine crease 8, and a part of rear cover member 4 which extends beyond an edge of coupling tab stack 1. Further indicated is the position of the sheet crease line 22 in the rear cover member.

FIG. 10B shows cover 21 in partially coupled state. Shown is the rear side of coupling tab stack 1, rear cover member 4, coupling tabs 6 of cover 21 which are in engagement with coupling tabs 2 of coupling tab stack 1. A subsequent step in coupling of cover 21 to coupling tab stack 1 is to fold cover 21 round coupling tab stack 1 so that rear cover member 4 is arranged against the rear side of coupling tab stack 1 as shown in FIG. 10A.

The present invention is described in the foregoing on the basis of several preferred embodiments. Different aspects of different embodiments are deemed described in combination with each other, wherein all combinations which can be deemed by a skilled person in the field as falling within the scope of the invention on the basis of reading of this document are included. These preferred embodiments are not limitative for the scope of protection of this document. The rights sought are defined in the appended claims.

The present invention further relates to a cover for supporting preferably a rear side of a coupling tab stack and/or for leaving substantially uncovered a title page of the coupling tab stack, the cover comprising:
a front cover member for placing at a front side of the stack;
a rear cover member for placing at a rear side of the stack and connected to the front cover member, and
front coupling means, such as coupling tabs, for coupling the front cover member to the front side of the stack, which front coupling means are arranged on an edge of the front coupling member.

An advantage of this cover is that in the coupled state, when a user is holding an assembly of the cover and the coupling tab stack, the coupling tab stack is supported on the rear side by the rear cover member, and that the title page of the coupling tab stack is at the same time visible to the user.

The cover is further foldable, preferably by means of a crease line, at a transition between the front coupling means and the front cover member for the purpose of folding the front cover member over the coupling tabs of the cover, preferably following coupling of the coupling tabs of the cover to the coupling tabs of the coupling tab stack. It is then possible to fold the cover round a spine part of the coupling tab stack so that the rear cover member of the cover is arranged on the rear side of the coupling tab stack.

The front cover member further has a width which is equal to or greater than the coupling tabs for the purpose of protecting the coupling tabs with the front cover member in the coupled state when the front cover member has been folded over the coupling tabs of the cover. An advantage hereof is that a substantially smooth appearance is imparted to the assembly of coupling tab stack and cover in that the coupling tabs are not visible during use of the assembly. A secondary advantage is that the coupling tabs are protected from damage by the cover, this being advantageous when the stack is taken apart and reassembled.

The present invention further relates to a cover comprising a spine crease or spine part on a spine side for connecting the front cover member and the rear cover member at least in an assembled state with the stack. It is noted that the spine part can be assembled from two spine creases arranged at mutual distance from each other. An advantage of the spine crease or the spine part is that, during folding of the cover round the coupling tab stack, the cover is easily foldable at the spine crease or spine part. The folding position of the cover is determined by a positioning of the spine crease. In the case the cover is folded repeatedly, the cover will further be folded each time at the same location, i.e. the spine crease or spine part, whereby the appearance of the cover is maintained despite repeated folding of the cover.

The present invention also relates to a cover com-prising a sheet crease line which is provided in the rear cover member for the purpose of providing in a coupled state a hinge action at a transition between the coupling tabs of the coupling tab stack and a remaining part of the coupling tab stack. The sheet crease line is advantageous when a user of the cover leafs through the stack when the cover and the stack are in the assembled state, for instance in order to read text printed on the sheets of the stack. During this operation the user will fold the stack with the cover so as to thus be better able to read the text on the sheet. An advantage of the sheet crease line is that the cover folds better, particularly when the sheet crease line corresponds to the fold line defined by the positioning of the coupling tabs of the coupling tab stack. This allows the combination of the cover and the stack to be more readily folded open. A further advantage of the sheet crease line is that no fold lines occur at random positions of the cover. A fold line at a random position of the cover can give the whole a sloppy and untidy appearance, this being prevented by the sheet crease line.

It is further possible for the rear cover member to extend in the coupled state at least partially or wholly over the rear side of the coupling tab stack, or for the rear cover member to extend in the coupled state beyond at least one edge of the coupling tab stack. Support is in this way provided to the coupling tab stack in the coupled state, whereby it is possible for a user to hold the assembly of the cover and a coupling tab stack at the position of at least the coupling tabs of the coupling tab stack, so that it is for instance possible for the user to hold the assembly with one hand and to leaf through the coupling tab stack with the other hand.

A transparent protective element is optionally pro-vided on the front cover member for the purpose of pro-tecting the title page of the coupling tab stack from dirt in the surrounding area.

1.-16. (canceled)

17. A cover for at least partially enclosing a stack for application with a coupling tab stack, the stack comprising at least two sheets, the cover comprising:
a front cover member for placing at the front side of the stack;
a rear cover member for placing at the rear side of the stack and connected to the front cover member,
a spine crease or spine part on a spine side for connecting the front cover member and the rear cover member at least in the assembled state with the stack, and
front coupling means and/or rear coupling means comprising coupling tabs for coupling to coupling tabs sheets of the coupling tab stack of a respective front or rear cover member to the respective side of the stack.

18. The cover as claimed in claim 17, wherein the front coupling means and/or the rear coupling means comprise attaching means, such as adhesive means, for adhesion to the respective side of the stack.

19. The cover as claimed in claim 17, wherein the front cover member and/or the rear cover member comprises a sheet crease line for the purpose of providing a hinge action at a transition between the coupling tabs and the sheet portions of the sheets forming a coupling tab stack.

20. The cover as claimed in claim 17, wherein the coupling means comprise adhesive means for adhering to the stack from the spine side of the cover as seen from a position beyond the sheet crease line, preferably adjacently of the sheet crease line or less than a strip width of the adhesive means removed there-from.

21. The cover as claimed in claim 17, wherein the coupling means of coupling means for first coupling comprise adhesive means for adhering to the coupling tabs of the coupling tab stack.

22. The cover as claimed in claim 17, wherein the front cover member and/or the rear cover member extend over a part or the whole of the surface of the stack.

23. The cover as claimed in claim 18, further comprising at least one adhesive means protective element, such as a pull strip, for covering the adhesive means up to the moment of adhering thereof to the coupling tab stack.

24. The cover as claimed in claim 23, wherein the adhesive means protective element takes a dual form in a longitudinal direction thereof for pulling thereof from one side along the length out of an assembly of the stack and the cover.

25. The cover as claimed in claim 17, wherein the protective device is manufactured at least partially from a material selected from the group comprising paper, cardboard, plastic, leather and/or a combination thereof.

26. The cover as claimed in claim 17, wherein the cover is formed integrally and can preferably have an envelope-like structure.

27. A coupling element for mutually coupling two coupling tab stacks, comprising:
front coupling means for coupling to a first of the two coupling tab stacks; and
rear coupling means for coupling to a second of the two coupling tab stacks and connected to the first coupling means,
wherein a folding crease is provided between the first coupling means and the second coupling means.

28. The coupling element as claimed in claim 27, further comprising attaching means, such as adhesive means, for mutually connecting the front coupling means and the rear coupling means in the assembled state and/or where-in the front coupling means and/or rear coupling means comprise coupling tabs.

29. A folder for receiving one or more coupling tab stacks, comprising:
a front cover member for placing at the front side of the stack;
a rear cover member for placing at the rear side of the stack and connected to the front cover member;
a spine crease on a spine side for connecting the front cover member and the rear cover member at least in the assembled state with the stack, and
at least one coupling means for coupling the coupling tab stack.

30. The folder as claimed in claim 29, wherein the coupling means forms part of the spine part and/or forms the spine part.
